(19) United States
(12) Patent Application Publication
(10) Pub. No.: US 2012/0024090 A1
(43) Pub. Date: Feb. 2, 2012

(54) TORQUE-TRANSMITTING DEVICE

(76) Inventor: Tae Ho Youn, Seoul (KR)

(21) Appl. No.: 13/262,665

(22) PCT Filed: Apr. 2, 2010
(86) PCT No.: PCT/KR10/02030

§ 371 Date: Oct. 3, 2011

(30) Foreign Application Priority Data
Apr. 3, 2009 (KR) 10-2009-0028752

(51) Int. Cl. F16H 19/04; F16H 21/00

(52) U.S. Cl. 74/34; 74/25

(57) ABSTRACT

A torque-transmitting device uses the principle of leverage in such a way that torque input at one end of a lever can become a greater torque per unit time at the other end of the lever, and can be achieved in a uniform fashion. The torque-transmitting device of the present invention comprises: a drive motor; a first mounting unit for rotatably mounting a rotational drive body which rotates on receiving a drive force from the drive motor; a second mounting unit provided at a predetermined distance from the first mounting unit; a lever which is rotatably secured on a support member provided between the first mounting unit and the second mounting unit, and of which one end is mounted on the first mounting unit where it turns as it is driven by the drive motor and of which the other end is mounted on the second mounting unit where it turns; an actuator which is linked to the other end of the lever and performs a linear reciprocating motion as the lever turns in the top-to-bottom direction; and a torque device for converting the linear reciprocating motion of the actuator into a rotational motion and generating torque for driving a predetermined loading device.

### BACKGROUND OF THE INVENTION

The present invention relates to a torque-transmitting device, and more particularly, to a torque-transmitting device using a lever, which can increase torque using the principle of the lever.

In general, levers have been widely used in various fields in modern society because the levers have a merit that they can gain a greater force with a small force in such a fashion that a bar turns on a predetermined position when a user applies force to an end portion of the bar.

Such levers have the fulcrum formed at the center of the turning lever, the force point where force is applied, and the point of action of the force applied at the end portion of the bar to an object.

The levers are classified into a first class lever in which the fulcrum is located between the force point and the point of action, a second class lever in which the point of action is located between the fulcrum and the force point, and a third class lever in which the force point is located between the fulcrum and the point of action.

An efficiency of force using the lever is decided depending upon a ratio of a magnitude of force, which is applied to the force point, to an operation distance of the bar and a ratio of a distance between the fulcrum and the point of force to a distance between the fulcrum and the point of action.

In order to apply force to an object using the principle of the lever, a linear directional force is applied to an end portion of the bar to move the position of the force point, and then, the position of the bar corresponding to the point of action is also changed and at the same time, the movement distance of the bar is also reduced, and hence, at the point of action, the lever can produce a greater force than the force applied to the force point.

Such a principle of the lever has been used through various types of modification in daily life and in industrial sites, but has not yet been used for a purpose to generate a strong torque at an output side by transmitting torque and amplifying torque.

### SUMMARY OF THE INVENTION

Accordingly, the present invention has been made in an effort to solve the above-mentioned problems occurring in the prior arts, and it is an object of the present invention to provide a torque-transmitting device, which can convert torque input at one end portion of a lever into a greater force at the other end portion of the lever using the principle of lever to thereby gain a great rate of production.

To achieve the above objects, the present invention provides a torque-transmitting device including: a driving motor; a first mounting part having a driving rotor rotatably mounted, the driving rotor rotating by receiving a driving force from the driving motor; a second mounting part spaced apart from the first mounting part at a predetermined interval; a lever rotatably fixed on a support member disposed between the first mounting part and the second mounting part, the lever having one end portion mounted on the first mounting part and being rotated by the driving motor and the other end portion rotatably mounted on the second mounting part; an actuator connected with the other end portion of the lever in such a fashion as to do a rectilinear reciprocating motion as the lever rotates vertically; and a torque device adapted for converting the rectilinear reciprocating motion of the actuator into a rotary motion to thereby generate torque to operate a predetermined loaded device.

Moreover, preferably, the torque device includes: a first clutch that drivingly rotates relative to the rectilinear motion of the actuator in one direction but idly rotates relative to the rectilinear motion of the actuator in the opposite direction; and a second clutch that idly rotates relative to the rectilinear motion of the actuator in one direction but drivingly rotates relative to the rectilinear motion of the actuator in the opposite direction.

Furthermore, it is preferable that the torque device further includes: a first shaft rotating as a main shaft of the first clutch and providing a driving force to a loaded device; and a second shaft rotating as a main shaft of the second clutch and generating torque to be transmitted to the first shaft.

Additionally, the torque device further includes: a first driving gear rotatably connected to the first shaft; a second driving gear rotatably connected to the second shaft; and a connection member connected to the first driving gear and the second driving gear in such a fashion that the first driving gear and the second driving gear transmit the driving force mutually to rotate in the same direction, the connection member transmitting the torque of the second shaft to the first shaft.

In addition, the actuator includes: a first rack gear part that is disposed on one side of the actuator in such a way as to interlock the first clutch, the first rack gear part drivingly or idly rotating the first clutch according to a rectilinear reciprocating motion; and a second rack gear part that is disposed on the other side of the actuator in such a way as to interlock the second clutch, the second rack gear part drivingly or idly rotating the second clutch according to a rectilinear reciprocating motion.

Moreover, the torque-transmitting device further includes: laterally movable roller units respectively disposed at one end portion and the other end portion of the lever and moving in a lateral direction when the lever is rotated to thereby guide a motion of the lever; and vertically movable roller units mounted on the same axis as the laterally movable roller units and moving in a vertical direction when the lever is rotated to thereby guide the motion of the lever.

Furthermore, each of the laterally movable roller units and the vertically movable roller units includes: a first plate; a second plate spaced apart from the first plate at a predetermined interval and opposed to the first plate; and a plurality of rollers disposed between the first plate and the second plate, respectively rotatably mounted on a plurality of rotary centers, which are spaced apart from each other at predetermined intervals and arranged in parallel, the rollers protruding to one side and the other side of the first plate and the second plate.

The torque-transmitting device according to the present invention can convert torque input at one end portion of a lever into a greater force at the other end portion of the lever using the principle of lever to thereby gain a great rate of production.

### BRIEF DESCRIPTION OF DRAWINGS

FIG. 1 is a perspective view of a torque-transmitting device according to a first preferred embodiment of the present invention.

FIG. 2 is a perspective view concretely showing hidden parts of the torque-transmitting device of FIG. 1, from which some parts of the torque-transmitting device are omitted.

FIG. 3 is an exploded perspective view concretely showing a lever and the torque-transmitting device of FIG. 1.

FIGS. 4 and 5 are views showing operations of the torque-transmitting device of FIG. 1, wherein FIG. 4 illustrates an operation when one end portion of the lever goes down and FIG. 5 illustrates an operation of the torque-transmitting device in the condition of FIG. 4.

FIG. 6 is a view showing an operation of the torque-transmitting device of FIG. 1 when the end portion of the lever goes up.

FIG. 7 is a view showing an operation of the torque-transmitting device in the condition illustrated in FIG. 6.

FIG. 8 is a perspective view of a torque-transmitting device according to a second preferred embodiment of the present invention.

FIG. 9 is a perspective view showing configurations of a first torque-transmitting device and a second torque-transmitting device illustrated in FIG. 8.

FIG. 10 is a view showing an operation of the torque-transmitting device of FIG. 1.

FIG. 11 is a view showing an operation of the torque-transmitting device in the condition illustrated in FIG. 10.

FIG. 12 is a view showing another operation of the torque-transmitting device according to the first preferred embodiment of FIG. 1.

FIG. 13 is a view showing an operation of the torque-transmitting device in the condition illustrated in FIG. 12.

### DETAILED DESCRIPTION OF THE INVENTION

Reference will be now made in detail to the preferred embodiment of the present invention with reference to the attached drawings.

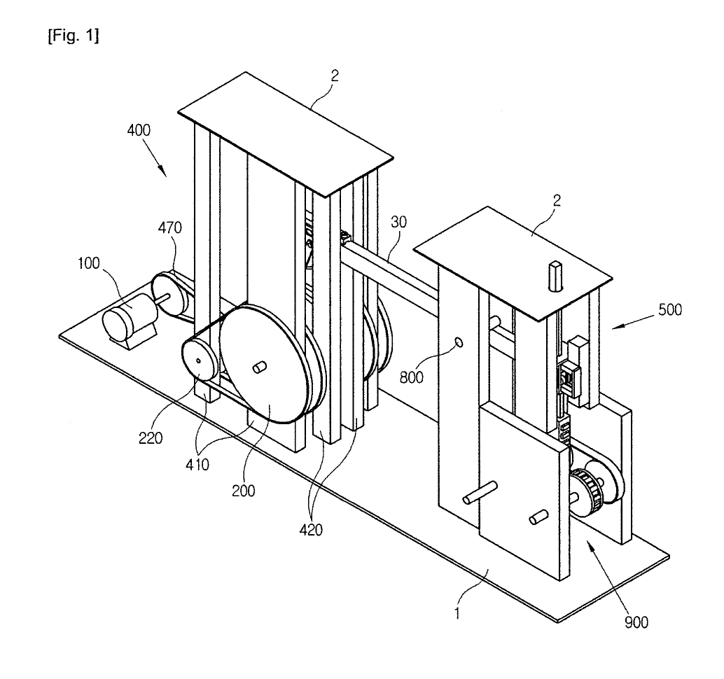

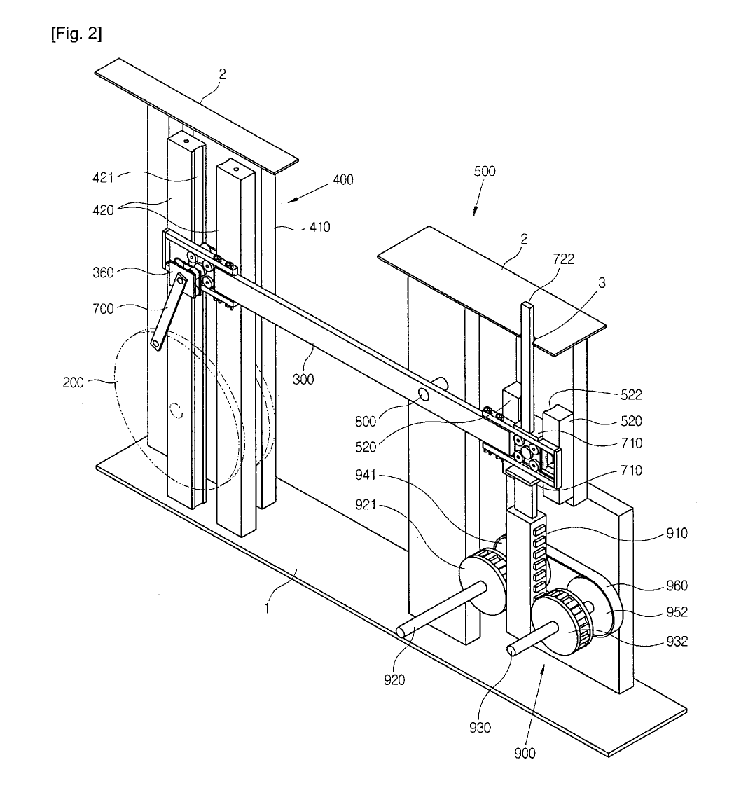

First, referring to FIGS. 1 and 2, the entire configuration of a torque-transmitting device according to a first preferred embodiment of the present invention will be described in brief.

As shown in FIGS. 1 and 2, the torque-transmitting device according to the present invention includes a driving motor 100, a driving rotor 220, a slave rotor 200, a lever 300, a first mounting part 400, a second mounting part 500, and a torque-transmitting device 300.

The first mounting part 400 is a part where one end portion of the lever 300 to which force is inputted is located, and includes first main support rods 410 and first vertically moving rods 420.

Two first main support rods 410 are spaced apart from each other at a predetermined interval and face each other.

Moreover, the first main support rods 410 includes: a driving connection shaft 411 to which the driving rotor 220 is connected; and a slave connection shaft 412 to which the slave rotor 200 is connected. In this instance, the driving rotor 220 and the slave rotor 200 are connected with each other by a belt or a chain B to thereby transmit driving power.

The first vertically moving rods 420, to which one end portion of the lever 300 is connected, are mounted on the first main support rods 410. Two first vertically moving rods 420 in a pair are in a bar shape like the first main support rods 410 and face with each other at a predetermined interval.

Each of the first vertically moving rods 420 includes a first guide rail 421 formed on the inner face thereof along a longitudinal direction. The first guide rail 421 is adapted to guide the end portion of the lever 300 to do a vertical movement smoothly.

A fixing plate 2 is joined to upper faces of the first main support rods 410 and the first vertically moving rods 420 in such a way as to fix the positions of the first main support rods 410 and the first vertically moving rods 420.

The driving motor 100 is connected with the driving connection shaft 411 by a connection belt 470, and the driving power transferred from the driving motor 100 is transferred to the driving connection shaft 411. The driving connection shaft 411 rotates the driving rotor 220 and vertically moves the end portion of the lever 300 while the slave rotor 200 is rotated by the belt or chain B.

In this instance, as shown in FIG. 2, driving rods 700 are fixed and disposed at the end portion of the lever 300 and the slave rotor 200, and one end portion of the driving rod 700 is eccentrically fixed to the slave rotor 200 in such a fashion as to be rotatably connected in an eccentric state, and the other end portion of the driving rotor 700 is fixed at the end portion of the lever 300.

In the meanwhile, a fulcrum 800 of the lever 300 is rotatably fixed on a support member 501 mounted between the first mounting part 400 and the second mounting part 500.

It is preferable that a distance between the support member 501 and the first mounting part 400 is longer than a distance between the support member 501 and the second mounting part 500 and a distance between one end portion of the lever 300 and the fulcrum 800 is longer than a distance between the fulcrum 800 and the other end portion of the lever 300. Moreover, the magnitude of force applied to the other end portion of the lever 300 can be controlled by adjusting the ratio of the distances.

Furthermore, second main support rods 510 are mounted on the second mounting part 500 to support the other end portion of the lever 300. In this instance, it is preferable that the other end portion of the lever 300 is supported by the second main support rods 510 while guiding vertically moving parts.

Additionally, a torque device 900 connected with the other end portion of the lever 300 is installed on the second mounting part 500, and will be described in detail later.

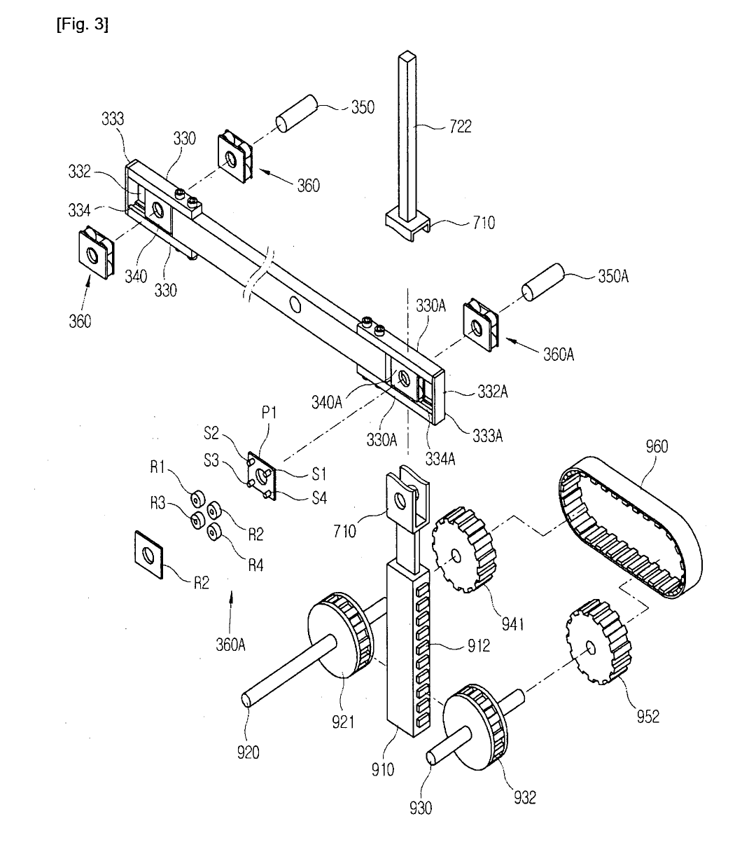

In the meantime, referring to FIG. 3, the lever 300 and peripheral units used for the torque device 900 according to the first preferred embodiment of the present invention will be described in more detail.

As shown in FIG. 3, the lever 300 of a single body is illustrated in the drawings, but it is not restricted to the drawings and levers of various forms, for instance, a lever, which is made by two parts combined with each other, may be also used.

First guide rods 330 are joined to upper and lower faces of the one end portion of the lever 300, and each of the first guide rods 330 is formed to extend from a first lever 310 to one side, so that a first space portion 332 is formed between the first guide rods 330. Moreover, a first blocking plate 333 is mounted at one end portion of each first guide rod 330 to thereby block the side of the first space portion 332.

In this instance, a first auxiliary guide rail 334 is formed on the inner face of each first guide rod 330, a first laterally movable roller unit 340 is inserted and mounted in the first space portion 332 between the first guide rods 330, and upper and lower rollers of the first laterally movable roller unit 340 are seated on the first auxiliary guide rail 334 of the first guide rod 330.

Moreover, the first laterally movable roller unit 340 has a through hole formed at the center thereof, and a penetration shaft 350 is inserted into the through hole. Furthermore, first vertically movable roller units 360 for guiding a vertical movement of the first lever 310 are respectively mounted on both ends of the penetration shaft 350.

As shown in FIG. 2, the right and left rollers of the first vertically movable roller units 360 are respectively seated and connected onto the first guide rails 421 of the first vertically moving rods 420.

Meanwhile, second guide rods 330A are respectively mounted on upper and lower faces of the other end portion of the lever 300. A second space 332A is formed between the second guide rods 330A and a second blocking plate 333A is joined to one side to thereby block the side.

In addition, a second auxiliary guide rail 334A is formed on the inner face of the second guide rod 330A and second laterally movable roller units 340A are mounted inside a second space portion 332A, and hence, the upper and lower rollers are seated on the second auxiliary guide rail 334A. In this instance, it is preferable that the second laterally movable roller units 340A have the same structure as the first laterally movable roller units 340.

Moreover, a second penetration shaft 350A is mounted at the center of the second auxiliary guide rail 334a, and second vertically movable roller units 360A are mounted at both ends of the second penetration shaft 350A. It is preferable that the second vertically movable roller units 360A have the same structure as the first vertically movable roller units 360.

Therefore, when the lever 300 rotates around the fulcrum 800, the laterally movable roller units 340 and 340A guide the motion of the lever 300 while moving in a lateral direction, and the vertically movable roller units 360, 360A guide the motion of the lever 300 while moving in a vertical direction, so that the lever 300 can minimize friction force and smoothly work without overload.

Now, concrete structures of the laterally movable roller units or the vertically movable roller units (hereinafter, called “roller unit”) will be described in detail.

The roller units include a first plate P1, a second plate P2, and four rollers R1, R2, R3 and R4, which are disposed between the first plate P1 and the second plate P2.

The first plate P1 and the second plate P2 are spaced apart from each other at a predetermined interval and are faced with each other.

The first plate P1 (or the second plate P2) includes: rotary centers S1, S2, S3 and S4 that are formed on the inner face thereof in parallel and spaced apart from each other at predetermined intervals; and rollers R1, R2, R3 and R4 respectively rotatably mounted on the rotary centers S2, S2, S3 and S4.

The rollers R1, R2, R3 and R4 respectively protrude toward one end side and the other end side of the first plate P1 and the second plate P2, and the protruding roller portions rotatably move along the guide rail.

In the meantime, FIG. 3 shows an exploded perspective view of the torque device 900 as shown in FIGS. 1 and 2. Referring to FIG. 3, the torque device 900 of the first preferred embodiment illustrated in FIGS. 1 and 2 will be described in more detail.

A connection part 710 that is perforated by the second penetration shaft 350A and vertically moves along the motion of the other end portion of the lever 300 is disposed at the other end portion of the lever 300. For your convenience, the connection part 710 is in a cut form in FIG. 3, but preferably, the connection part 710 may have an integrated form and be rotatably fixed at the other end portion of the lever 300 by the second penetration shaft 350A.

It is preferable that an actuator 910 is disposed on one side of the connection part 710 and a guide bar 722 is disposed on the other side of the connection part 710. In FIG. 3, the actuator 910 is located below the connection part 710 and the guide bar 722 is located above the connection part 710, and vice versa.

The connection part 710 shows a rectilinear motion in a vertical direction as the lever 300 rotates around the fulcrum 800.

In this instance, because the connection part 710 is mounted rotatably on the second penetration shaft 350A, the lever 300 can move in the vertical direction even though it rotates around the fulcrum 800.

The guide bar 722 is inserted into a guide hole 3 to guide a vertically rectilinear motion of the connection part 710, and the actuator 910 disposed on one side of the connection part 710 is also guided by the first and second clutches 921 and 932 to do the rectilinear motion.

Meanwhile, as shown in FIGS. 1 to 3, the first clutch 921 and the second clutch 932 are respectively located on one side and the other side of the actuator 910. In this instance, the first clutch 921 drivingly rotates relative to a downward rectilinear motion of the actuator 910 and idles relative to an upward rectilinear motion, on the contrary to the above, the second clutch 932 idles relative to the downward rectilinear motion of the actuator 910 and drivingly rotates relative to the upward rectilinear motion.

A first rack gear part (not shown in the drawings, opposed to a second rack gear part of the actuator 910 in FIG. 3) is disposed on a corresponding face to the first clutch 921 of the actuator 910 and interlocks the first clutch 921. Additionally, a second rack gear part 912 is disposed on a corresponding face to the second clutch 932 and interlocks the second clutch 932.

Furthermore, as shown in FIGS. 1 to 3, the torque device 900 includes: a first shaft 920 adapted for providing a driving force to a loaded device while rotating as the central shaft of the first clutch 921; and a second shaft 930 adapted for generating torque, which will be transferred to the first shaft 920, while rotating as the central shaft of the second clutch 932.

When the actuator 910 descends, the first clutch 921 rotates the first shaft 920 while drivingly rotating (which is a contrary concept of idle rotation and is a driving force to drive the loaded device), and in this instance, the second clutch 932 rotates in the opposite direction of the first clutch 921 but idly rotates without any rotation of the second shaft 930.

When the actuator 910 ascends, the second cultch 932 rotates the second shaft 930 while drivingly rotating, and in this instance, the first clutch 921 rotates in the opposite direction of the second clutch 932 but idly rotates without any rotation of the first shaft 920.

In the meantime, a first driving gear 941 is rotatably connected to the first shaft 920 and a second driving gear 952 is rotatably connected to the second shaft 930.

Furthermore, the first driving gear 941 and the second driving gear 952 are connected with each other by a connection member 960, so that the second driving gear 952 can be rotated by the connection member 960 when the first driving gear 941 is rotated and the first driving gear 941 is rotated by the connection member 960 when the second driving gear 952 is rotated.

Accordingly, due to the connection member 960, the first driving gear 941 and the second driving gear 952 can be rotated in the same direction while transmitting driving force to each other.

As shown in FIG. 3, the connection member 960 may be a timing belt having a toothed structure that can be teeth-coupled with toothed structures of the first driving gear 941 and the second driving gear 952.

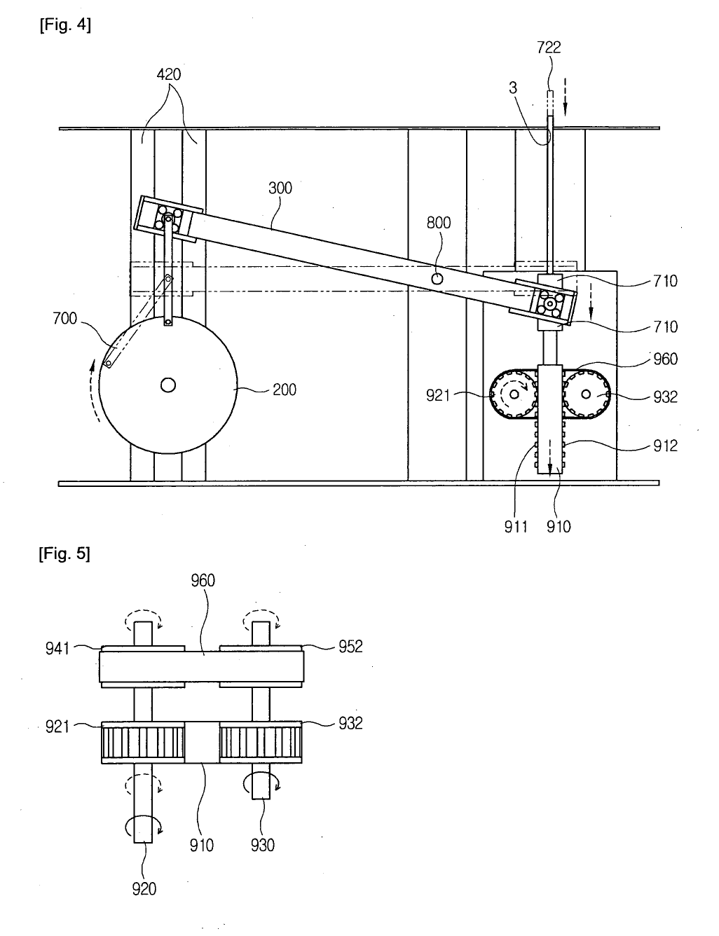

Hereinafter, referring to FIGS. 4 to 7, an operation of the torque-transmitting device according to the present invention will be described.

FIGS. 4 and 5 illustrate the operation of the torque-transmitting device according to the preferred embodiment of the present invention of FIG. 1, wherein FIG. 4 shows an operation when the other end portion of the lever descends and FIG. 5 shows an operation of the torque-transmitting device in the condition of FIG. 4.

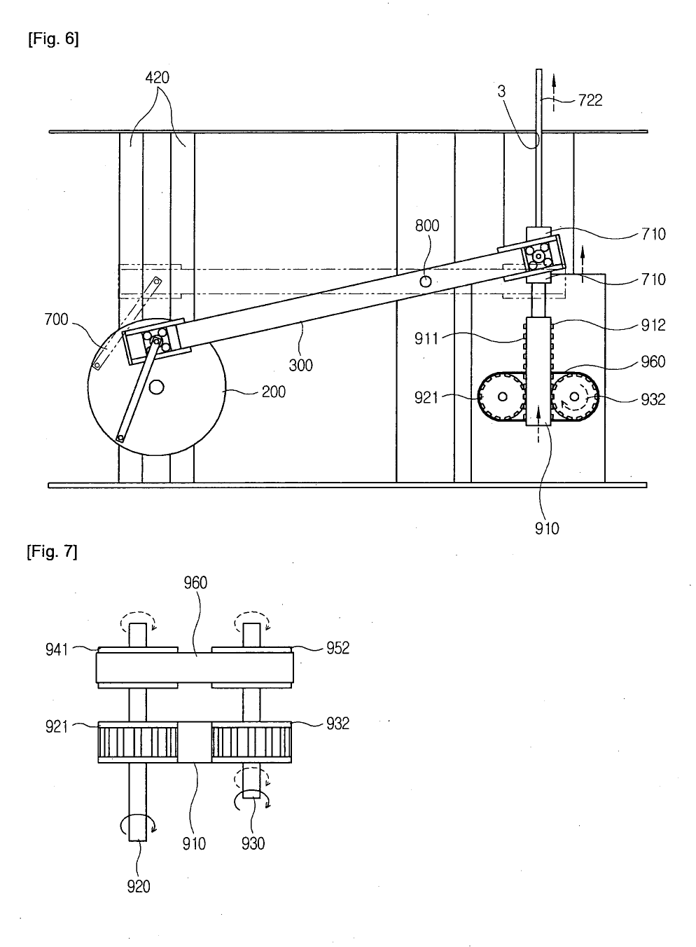

Additionally, FIG. 6 shows an operation when the other end portion of the lever ascends in the torque-transmitting device illustrated in FIG. 1, and FIG. 7 shows an operation of the torque-transmitting device in the condition of FIG. 6.

First, as shown in FIG. 4, when the driving motor is operated and rotates the slave rotor 200, the driving rod 700 which is eccentrically fixed to the slave rotor 200 moves in such a way as to move one end portion of the lever 300 in the upward and downward directions.

In this instance, the vertically movable roller units and the laterally movable roller units are moved along the guide rail and the auxiliary guide rail to thereby make the vertical rectilinear reciprocating motion of the lever 300 smoother, and because it is previously described, it will be omitted.

When one end portion of the lever 300 ascends higher than the fulcrum 800 while the slave rotor 200 rotates, the other end portion of the lever 300 descends.

In this instance, the actuator 910 disposed on the first connection part 710 connected to the other end portion of the lever 300 is also descended, and the actuator 910 descends and drivingly rotates the first clutch 921 (see a part indicated by a dotted arrow in the drawing) and idles the second clutch 932. (The second clutch 932 rotates in the opposite direction of the first clutch 921 but idly rotates)

In this instance, a first rack gear part 911 of the actuator 910 can convert the rectilinear motion of the actuator 910 into a rotary motion because the first rack gear part 911 interlocks the first clutch 921.

While the first clutch 921 drivingly rotates, the first shaft 920 is rotated and the first driving gear 941 is also rotated by the rotation of the first shaft 920.

While the first driving gear 941 is rotated, the connection member 960 is also rotated and the second driving gear 952 is also rotated in the same direction as the first driving gear 941 by the connection member 960. Moreover, while the second driving gear 952 rotates, the second shaft 930 is also rotated.

In the meantime, the solid line arrow presents a rotation of the shaft and the dotted line arrows present rotations of the clutch and the driving gear.

As shown in FIG. 5, when the actuator 910 moves down, only the second clutch 932 idles but the first clutch 921, the first shaft 920, the first driving gear 941, the second driving gear 952, and the second shaft 930 are all rotated.

In this instance, the first shaft 920 rotates halfway. The driving force for the remaining half rotation is obtained by the second clutch 932 working while the actuator 910 moves up.

That is, as shown in FIG. 6, when one end portion of the lever 300 moves down, the other end portion of the lever 300 moves up, and in this instance, the actuator 910 moves upward and drivingly rotates (see the dotted line arrow in FIG. 6) the second clutch 932 but idly rotates (the first clutch 921 rotates in the opposite direction to the second clutch and idly rotates).

In this instance, because the second rack gear part 912 of the actuator 910 interlocks the second clutch 932, the rectilinear motion of the actuator 910 can convert the rectilinear motion of the actuator 910 into a rotary motion of the second clutch 932.

While the second clutch 932 drivingly rotates, the second shaft 930 is rotated, and the second driving gear 952 is rotated by the rotation of the second shaft 930.

While the first driving gear 952, the connection member 960 is also rotated, and the first driving gear 941 is also rotated in the same direction as the second driving gear 952 by the connection member 960. Moreover, when the first driving gear 941 rotates, the first shaft 920 is also rotated.

In FIG. 7, the solid line arrow presents the rotation of the shaft and the dotted line arrow presents the rotations of the clutch and the driving gear.

As shown in FIG. 7, when the actuator 910 moves up, only the first clutch 921 idly rotates, but the second clutch 932, the second shaft 930, the second driving gear 952, the first driving gear 941, and the first shaft 920 are all rotated.

In this instance, the first shaft 920 rotates as much as the remaining half rotation length, and hence, it can rotate in safety. That is, the first shaft 920 can rotate perfectly along the upward and downward movement of the actuator 910.

If the distance ranging from the one end portion of the lever 300 to the fulcrum 800 is longer than the distance ranging from the other end portion of the lever 300 to the fulcrum 800, when the lever 300 is operated, the force applied to the other end portion of the lever 300 may become greater than the forced applied to the one end portion of the lever 300.

Because greater power is applied to the other end portion of the lever 300 not the one end portion, the force to rotate the first shaft 920 and the second shaft 930 becomes greater, so that instant torques of the first shaft 920 and the second shaft 930 rotating by the greater force can be amplified, and hence, the rate of production can be also increased.

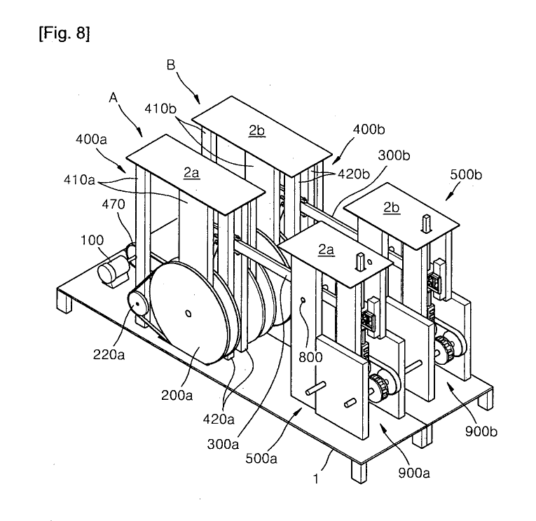

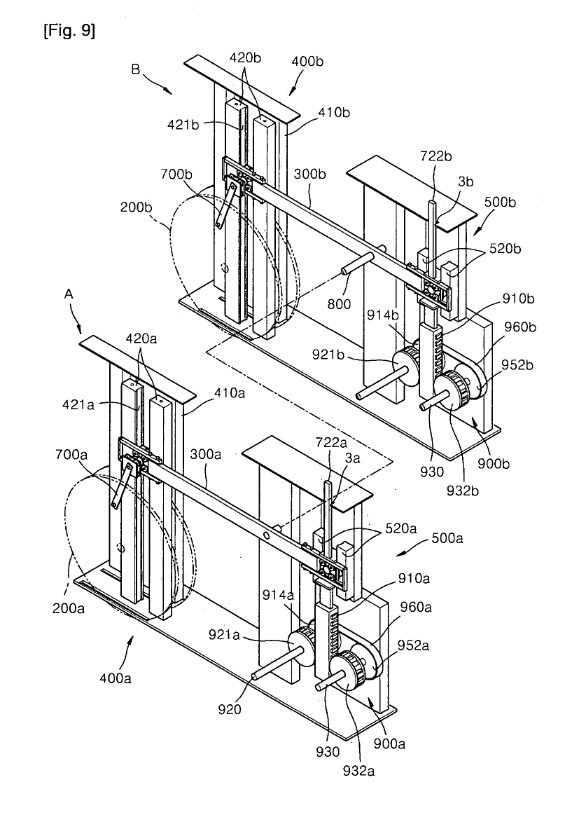

Meanwhile, referring to FIGS. 8 and 9, the entire configuration of the torque-transmitting device according to a second preferred embodiment of the present invention will be described in brief.

As shown in FIGS. 8 and 9, the torque-transmitting device according to the second preferred embodiment of the present invention provides a double structure that has a first torque-transmitting device A and a second torque-transmitting device B.

In FIG. 8, the first torque-transmitting device A and the second torque-transmitting device B are connected with each other, but in FIG. 9, the first torque-transmitting device A and the second torque-transmitting device B are separated from each other.

As shown in FIGS. 8 and 9, the structures of the first torque-transmitting device A and the second torque-transmitting device B are the same as the torque-transmitting device of FIG. 1. That is, the double structure of the torque-transmitting device according to the second preferred embodiment is virtually identical with a state where two torque-transmitting devices of FIG. 1 are mounted in parallel in such a way as to be connected with each other.

Here, the first torque-transmitting device A and the second torque-transmitting device B are respectively operated by a single driving motor 100, a first lever 300a and a second lever 300b are supported by a single fulcrum 800, and a first torque device 900a of the first torque-transmitting device A and a second torque device 900b of the second torque-transmitting device B respectively operate the first shaft 920 and the second shaft 930.

That is, as shown in FIGS. 8 and 9, the first torque-transmitting device A includes a first driving rotor 220a and a first slave rotor 200a driven by the driving motor 100, a first lever 300a, a first mounting part 400a, a second mounting part 500a, and the first torque device 900a. Additionally, the second torque-transmitting device B also includes a second driving rotor 220b and a second slave rotor 200b driven by the driving motor 100, a second lever 300b, a third mounting part 400b, a fourth mounting part 500b, and the second torque device 900b.

Furthermore, the detailed configuration and the operation principle of the torque-transmitting device according to the second preferred embodiment are also virtually identical with the detailed configuration of the torque-transmitting device according to the first embodiment, and hence, description of the detailed configuration illustrated in FIGS. 8 and 9 will be omitted.

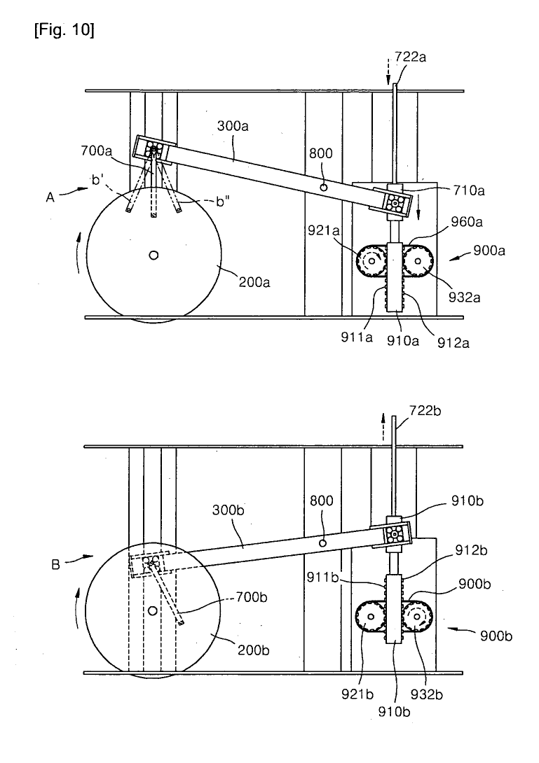

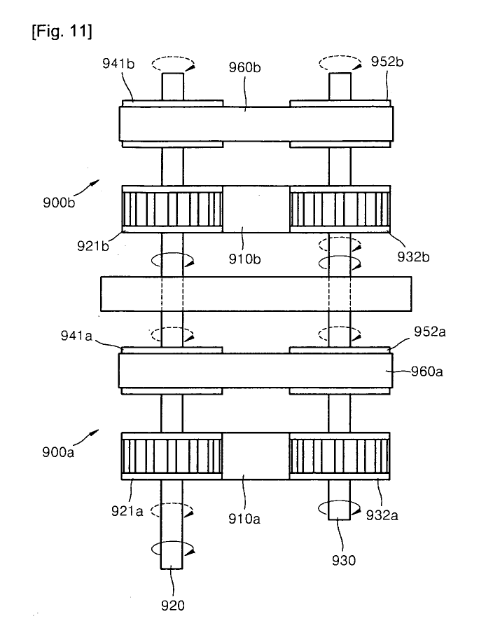

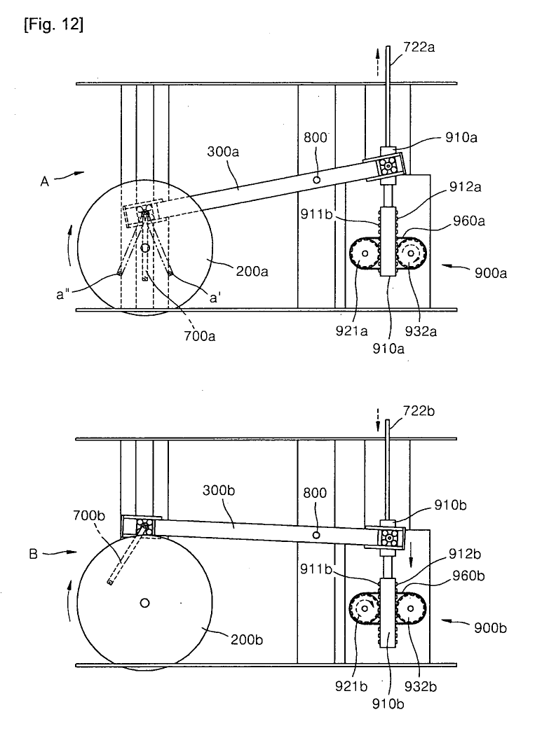

Meanwhile, FIGS. 10 to 13 illustrate the operation of the torque-transmitting device with the double structure according to the second preferred embodiment. FIG. 10 illustrates the operation of the torque-transmitting device in a state where a first driving rod 700a of the first torque-transmitting device A is located near the top dead point (b′˜b″) of the first slave rotor 200a and a second driving rod 700b of the second torque-transmitting device B is rotated toward the bottom dead point of the second slave rotor 200b. FIG. 11 illustrates the operation of the torque devices 900a and 900b in the condition illustrated in FIG. 10.

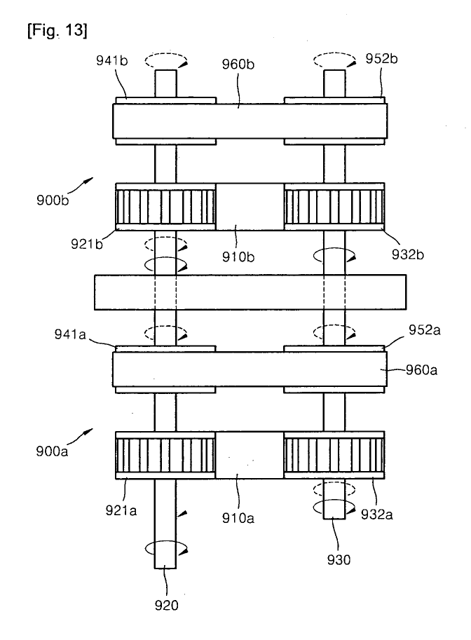

Moreover, FIG. 12 illustrates the operation of the torque-transmitting device in a state where the first driving rod 700a of the first torque-transmitting device A is located near the bottom dead point (a′˜a″) of the first slave rotor 200a and a second driving rod 700b of the second torque-transmitting device B is rotated toward the top dead point of the second slave rotor 200b. FIG. 13 illustrates the operations of the torque devices 900a and 900b in the condition of FIG. 12.

First, as shown in FIG. 10, when the driving motor is operated and the first driving rotor 200a and the second slave rotor 200b are respectively rotated, the first driving rod 700a and the second driving rod 700b eccentrically fixed to the first driving rotor 200a and the second slave rotor 200b upwardly or downwardly moves end portions of the first lever 300a and the second lever 300b while respectively moving.

In this instance, as shown in FIGS. 10 and 11, the first actuator 910a disposed on the first connection part 710a connected to the other end portion of the first lever 300a of the first torque-transmitting device A also moves down. While moving down, the first actuator 910a drivingly rotates the first clutch 921a (indicated as the dotted line arrow in the drawing) and idly rotates the second clutch 932a (the second clutch is rotated in the opposite direction of the first cultch but idles.).

In this instance, because a first rack gear part 911a of the first actuator 910a can convert a rectilinear motion of the first actuator 910a into a rotary motion of the first clutch 921a.

While drivingly rotating, the first clutch 921a rotates the first shaft 920, and the first driving gear 941a is also rotated by the rotation of the first shaft 920.

When the first driving gear 941a rotates, the first connection member 960a is also rotated, and the second driving gear 952a is also rotated in the same direction as the first driving gear 941a by the first connection member 960a. Furthermore, when the second driving gear 952a is rotated, the second shaft 930 is also rotated.

Additionally, the second actuator 910b disposed on the second connection part 710b connected to the other end portion of the second lever 300b of the second torque-transmitting device B moves up. While moving up, the second actuator 910b drivingly rotates the fourth clutch 932b (see the dotted line arrow in the drawing) and idly rotates the third clutch 921b (the third clutch rotates in the opposite direction of the fourth clutch but idles).

In this instance, because the fourth rack gear part 912b of the second actuator 910b interlocks the fourth clutch 932b, the rectilinear motion of the second actuator 910b can be converted into a rotary motion of the fourth clutch 932b.

While drivingly rotating, the fourth clutch 932b rotates the second shaft 930, and the fourth driving gear 952b is also rotated by the rotation of the second shaft 930.

While rotating, the fourth driving gear 952b rotates the second connection member 960b, and the third driving gear 941b is also rotated in the same direction as the fourth driving gear 952b due to the second connection member 960b. Furthermore, the third driving gear 941b rotates the first shaft 920 while rotating.

Accordingly, the first shaft 920 and the second shaft 930 are rotated by the first torque device 900a and the second torque device 900b)

In this instance, as shown in FIG. 10, when the first driving rod 700a of the first torque-transmitting device A passes near the top dead point of the first slave rotor 200a (in the drawing, a position between b′ and b″), the first lever 300a may be hardly operated, and hence, the first actuator 910a may hardly do the rectilinear motion.

Even in the above case, because the second lever 300b of the second torque-transmitting device B makes the second actuator 910b do the rectilinear motion, the second torque-transmitting device B can continuously drive the first shaft 920 and the second shaft 930 by additionally adding the first torque-transmitting device A.

In FIG. 11, the solid line arrow presents the rotation of the shaft and the dotted line arrow presents the rotations of the clutch and the driving gear.

Meanwhile, as shown in FIGS. 12 and 13, when the first driving rod 700a of the first torque-transmitting device A passes near the bottom dead point (position between a′ and a″ in FIG. 12), the first actuator 910a disposed on the first connection part 710a connected to the other end portion of the first lever 300a of the first torque-transmitting device A moves up, and the first actuator 910a drivingly rotates the second clutch 932a (see the dotted line arrow in the drawing) and idly rotates the first clutch 921a while moving up.

In this instance, as shown in FIGS. 12 and 13, because the second rack gear part 912a of the first actuator 910a interlocks the second clutch 932a, the rectilinear motion of the actuator 910a can be converted into a rotary motion of the second clutch 932a.

The second clutch 932a rotates the second shaft 930 while drivingly rotating, and the second driving gear 952a is rotated by the rotation of the second shaft 930.

The second driving gear 952a rotates the connection member 960a while rotating, and the first driving gear 941a is also rotated in the same direction as the second driving gear 952a by the connection member 960a. Moreover, the first driving gear 941a rotates the first shaft 920 while rotating.

Moreover, the second actuator 910b disposed on the second connection part 710b connected to the other end portion of the second lever 300b of the second torque-transmitting device B moves down. While moving down, the second actuator 910b drivingly rotates the second clutch 921b (see the dotted line arrow in the drawing) and idly rotates the fourth clutch 932b.

In this instance, because the third rack gear part 911b of the second actuator 910b interlocks the third clutch 921b, the rectilinear motion of the second actuator 910b can be converted into a rotary motion of the third clutch 921b.

The third clutch 921b rotates the first shaft 920 while drivingly rotating, and the third driving gear 941b is also rotated by the rotation of the first shaft 920.

When the third driving gear 941b is rotated, the second connection member 960b is also rotated, and the fourth driving gear 952b is rotated in the same direction as the third driving gear 941b by the second connection member 960b. Additionally, when the fourth driving gear 952b is rotated, the second shaft 930 is also rotated.

Accordingly, the first shaft 920 and the second shaft 930 are rotated by the first torque device 900a and the second torque device 900b.

In this instance, as shown in FIG. 12, when the first driving rod 700a of the first torque-transmitting device A passes near the bottom dead point of the first slave rotor 200a (in the drawing, the position between a′ and a″), the first lever 300a may be hardly operated, and hence, the first actuator 910a may hardly do the rectilinear motion.

Even in the above case, because the second lever 300b of the second torque-transmitting device B makes the second actuator 910b do the rectilinear motion, the second torque-transmitting device B can continuously drive the first shaft 920 and the second shaft 930 by additionally adding the first torque-transmitting device A.

The torque-transmitting device according to the present invention can convert torque input at one end portion of the lever into a greater force at the other end portion of the lever using the principle of lever to thereby gain a great rate of production.

1. A torque-transmitting device comprising:
a driving motor;
a first mounting part having a driving rotor rotatably mounted, the driving rotor rotating by receiving a driving force from the driving motor;
a second mounting part spaced apart from the first mounting part at a predetermined interval;
a lever rotatably fixed on a support member disposed between the first mounting part and the second mounting part, the lever having: one end portion mounted on the first mounting part and being rotated by the driving motor; and the other end portion rotatably mounted on the second mounting part;
an actuator connected with the other end portion of the lever in such a fashion as to do a rectilinear reciprocating motion as the lever rotates vertically; and
a torque device adapted for converting the rectilinear reciprocating motion of the actuator into a rotary motion to thereby generate torque to operate a predetermined loaded device.

2. The torque-transmitting device according to claim 1, wherein the torque device comprises:
a first clutch that drivingly rotates relative to the rectilinear motion of the actuator in one direction but idly rotates relative to the rectilinear motion of the actuator in the opposite direction; and
a second clutch that idly rotates relative to the rectilinear motion of the actuator in one direction but drivingly rotates relative to the rectilinear motion of the actuator in the opposite direction

3. The torque-transmitting device according to claim 2, wherein the torque device further comprises:
a first shaft rotating as a main shaft of the first clutch and providing a driving force to a loaded device; and
a second shaft rotating as a main shaft of the second clutch and generating torque to be transmitted to the first shaft.

4. The torque-transmitting device according to claim 3, wherein the torque device further comprises:
a first driving gear rotatably connected to the first shaft;
a second driving gear rotatably connected to the second shaft; and
a connection member connected to the first driving gear and the second driving gear in such a fashion that the first driving gear and the second driving gear transmit the driving force mutually to rotate in the same direction, the connection member transmitting the torque of the second shaft to the first shaft.

5. The torque-transmitting device according to claim 2, wherein the actuator comprises:
a first rack gear part that is disposed on one side of the actuator in such a way as to interlock the first clutch, the first rack gear part drivingly or idly rotating the first clutch according to a rectilinear reciprocating motion; and
a second rack gear part that is disposed on the other side of the actuator in such a way as to interlock the second clutch, the second rack gear part drivingly or idly rotating the second clutch according to a rectilinear reciprocating motion.

6. The torque-transmitting device according to claim 1, further comprising:
laterally movable roller units respectively disposed at one end portion and the other end portion of the lever and moving in a lateral direction when the lever is rotated to thereby guide a motion of the lever; and
vertically movable roller units mounted on the same axis as the laterally movable roller units and moving in a vertical direction when the lever is rotated to thereby guide the motion of the lever.

7. The torque-transmitting device according to claim 6, wherein each of the laterally movable roller units and the vertically movable roller units comprises:
a first plate;
a second plate spaced apart from the first plate at a predetermined interval and opposed to the first plate; and
a plurality of rollers disposed between the first plate and the second plate, respectively rotatably mounted on a plurality of rotary centers, which are spaced apart from each other at predetermined intervals and arranged in parallel, the rollers protruding to one side and the other side of the first plate and the second plate.

8. A torque-transmitting device comprising:
a driving motor;
a first torque-transmitting device including: a first mounting part having a first driving rotor rotatably mounted, the first driving rotor rotating by receiving a driving force from the first driving motor; a second mounting part spaced apart from the first mounting part at a predetermined interval; a first lever that is rotatably fixed on a first support member disposed between the first mounting part and the second mounting part and has one end portion mounted on the first mounting part and rotated by the first driving motor and the other end portion rotatably mounted on the second mounting part; a first actuator connected with the other end portion of the first lever in such a fashion as to do a rectilinear reciprocating motion as the first lever rotates vertically; and a first torque device adapted for converting the rectilinear reciprocating motion of the first actuator into a rotary motion to thereby generate torque; and
a second torque-transmitting device including: a third mounting part having a second driving rotor rotatably mounted, the second driving rotor rotating by receiving a driving force from the second driving motor; a fourth mounting part spaced apart from the third mounting part at a predetermined interval; a second lever that is rotatably fixed on a second support member disposed between the third mounting part and the fourth mounting part and has one end portion mounted on the third mounting part and rotated by the second driving motor and the other end portion rotatably mounted on the third mounting part; a second actuator connected with the other end portion of the second lever in such a fashion as to do a rectilinear reciprocating motion as the second lever rotates vertically; and a second torque device adapted for converting the rectilinear reciprocating motion of the second actuator into a rotary motion to thereby generate torque.

9. The torque-transmitting device according to claim 8, wherein the first torque device comprises: a first clutch that drivingly rotates relative to the rectilinear motion of the first actuator in one direction but idly rotates relative to the rectilinear motion of the first actuator in the opposite direction; and a second clutch that idly rotates relative to the rectilinear motion of the first actuator in one direction but drivingly rotates relative to the rectilinear motion of the first actuator in the opposite direction, and
wherein the second torque device comprises: a third clutch that drivingly rotates relative to the rectilinear motion of the second actuator in one direction but idly rotates relative to the rectilinear motion of the second actuator in the opposite direction; and a fourth clutch that idly rotates relative to the rectilinear motion of the second actuator in one direction but drivingly rotates relative to the rectilinear motion of the second actuator in the opposite direction

10. The torque-transmitting device according to claim 9, wherein each of the first and second torque devices further comprises:
a first shaft rotating as a main shaft of the first clutch and the third clutch and providing a driving force to a loaded device; and
a second shaft rotating as a main shaft of the second clutch and the fourth clutch and providing the driving force to the loaded device.

11. The torque-transmitting device according to claim 10, wherein the first torque device further comprises: a first driving gear rotatably connected to the first shaft; a second driving gear rotatably connected to the second shaft; and a first connection member connected to the first driving gear and the second driving gear in such a fashion that the first driving gear and the second driving gear transmit the driving force mutually to rotate in the same direction, the first connection member transmitting the torque of the second shaft to the first shaft, and
wherein the second torque device further comprises: a third driving gear rotatably connected to the first shaft; a fourth driving gear rotatably connected to the second shaft; and a second connection member connected to the third driving gear and the fourth driving gear in such a fashion that the third driving gear and the fourth driving gear transmit the driving force mutually to rotate in the same direction, the second connection member transmitting the torque of the second shaft to the first shaft

12. The torque-transmitting device according to claim 2, wherein the first actuator comprises: a first rack gear part that is disposed on one side of the actuator in such a way as to interlock the first clutch, the first rack gear part drivingly or idly rotating the first clutch according to a rectilinear reciprocating motion; and a second rack gear part that is disposed on the other side of the actuator in such a way as to interlock the second clutch, the second rack gear part drivingly or idly rotating the second clutch according to a rectilinear reciprocating motion, and
wherein the second actuator comprises: a third rack gear part that is disposed on one side of the second actuator in such a way as to interlock the third clutch, the third rack gear part drivingly or idly rotating the third clutch according to a rectilinear reciprocating motion; and a fourth rack gear part that is disposed on the other side of the second actuator in such a way as to interlock the fourth clutch, the fourth rack gear part drivingly or idly rotating the fourth clutch according to a rectilinear reciprocating motion.
